(19) United States
(12) Patent Application Publication
(10) Pub. No.: US 2007/0082630 A1
(43) Pub. Date: Apr. 12, 2007

(54) Radio frequency power amplifier circuit and method

(76) Inventors: Narendra Kumar Aridas, Kulim (MY); Joshua Khai Ho Lee, Kuching (MY)

Correspondence Address: MOTOROLA, INC., 1303 EAST ALGONQUIN ROAD, IL01/3RD, SCHAUMBURG, IL, 60196, US

(21) Appl. No.: 11/234,938

(22) Filed: Sep. 26, 2005

(51) Int. Cl. H01Q 11/12; H04B 1/04

(52) U.S. Cl. 455/127.2; 455/126

(57) ABSTRACT

A method (200) and circuit (100) for substantially maintaining an amplified constant envelope modulation signal at a constant pre-defined amplitude. The circuit (100) comprises a constant envelope modulation providing circuitry (104), a power amplifier (102), a power amplifier driver (106), a coupler (108) and a feedback circuit (110). In operation the sensor (110) has an output (120) that provides a radio frequency output signal proportional to an amplitude of an amplified constant envelope modulated radio frequency signal provided to the amplifier input (118) from the power amplifier driver (106). The feedback circuit (110) provides a gain control voltage a driver gain control input to maintain the constant envelope modulation signal at a constant pre-defined amplitude supplied to the amplifier input (118).

### FIELD OF THE INVENTION

The present invention relates generally to a radio frequency power amplifier circuit and method. In particular, the present invention relates to a radio frequency power amplifier circuit for constant envelope modulation and a method of maintaining an amplified constant envelope modulated radio frequency signal at a constant predefined amplitude.

### BACKGROUND

During operation of a power amplifier circuit comprising a Radio Frequency (RF) power amplifier, it is desirable to achieve relatively high amplifier efficiency across desired power levels (power modes). However, when considering a constant envelope modulated RF signal supplied to such a power amplifier circuit, the signal provided to the power amplifier can vary due to varying operating conditions of the circuit (i.e., temperature and supply voltage). Furthermore, with varying power level requirement from the power amplifier, suitable operating efficiency cannot be readily achieved. For any required operating power level, drain supply and the amplitude of the constant envelope modulated radio frequency signal at an amplifier input must be carefully selected and ideally maintained during circuit operation.

### SUMMARY OF THE INVENTION

According to an embodiment of the invention, there is provided a radio frequency power amplifier circuit comprising: a constant envelope modulation providing circuitry; a power amplifier driver having a driver gain control input, a driver signal output, and a driver signal input coupled to the constant envelope modulation providing circuitry; a power amplifier having an amplifier input coupled to the driver signal output; a sensor having a sensor output and a sensor input coupled with the amplifier input; and a feedback circuit having an input coupled to said sensor output and an output coupled to said driver gain control input. In operation, the sensor output provides a radio frequency output proportional to an amplitude of an amplified constant envelope modulated radio frequency signal provided to the amplifier input from the driver signal output. Also, the feedback circuit provides a gain control voltage to the driver gain control input, the gain control voltage having a value dependent on the radio frequency output thereby substantially maintaining the amplified constant envelope modulated radio frequency signal at a constant pre-defined amplitude.

According to another embodiment of the invention, there is provided a method for substantially maintaining a constant pre-defined amplitude of a constant envelope modulated radio frequency signal at an amplifier input of a radio frequency amplifier, the method comprising: selecting a voltage value provided at a control input of a feedback circuit; providing a radio frequency output signal that is proportional to an amplitude of a constant envelope modulated radio frequency signal from a power amplifier driver having an output coupled to the input of a power amplifier; and providing a gain control voltage to a gain control input of said driver, the gain control voltage having a value dependent on the radio frequency output signal and voltage value provided at the control input.

According to yet another embodiment of the invention, there is provided a method for substantially maintaining a constant pre-defined amplitude of a constant envelope modulated radio frequency signal at an amplifier input of a radio frequency amplifier, the method comprising: selecting a voltage value provided at a control input of a feedback circuit; providing a radio frequency output signal that is proportional to an amplitude of a constant envelope modulated radio frequency signal from a power amplifier driver having an output coupled to the input of a power amplifier; and providing a gain control voltage to a gain control input of said driver, the gain control voltage having a value dependent on the radio frequency output signal and voltage value provided at the control input.

### BRIEF DESCRIPTION OF THE FIGURES

In order that the invention may be readily understood and put into practical effect, reference will now be made to an exemplary embodiment as illustrated with reference to the accompanying figures, where like reference numerals refer to identical or functionally similar elements throughout the separate views. The figures together with a detailed description below, are incorporated in and form part of the specification, and serve to further illustrate the embodiments and explain various principles and advantages, in accordance with the present invention where:

FIG. 1 is a block diagram of the power amplifier circuit in accordance with an exemplary embodiment of the invention;

FIG. 2 illustrate a method for substantially maintaining a constant pre-defined amplitude of a constant envelope modulated radio frequency signal, the method being performed by the power amplifier circuit of FIG. 1;

FIG. 3 shows graphically simulation results of efficiency versus RF drive at 7.2V supply voltage for the power amplifier circuit of FIG. 1; and

FIG. 4 shows graphically simulation results of efficiency versus RF drive at 3.6V supply voltage for the power amplifier circuit of FIG. 1.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in combination of method steps and apparatus components relating to a radio frequency power amplifier circuit for a constant envelope modulated signal to substantially maintain the amplified signal at a constant predefined amplitude. Accordingly, the apparatus components and method steps have been represented by conventional symbols in the drawings, showing only those specific details that are pertinent to understand the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceeded by “comprises . . . a” does not, without more constraints, preclude the existence of additional identical elements in the process, method, article, or apparatus that comprises the element.

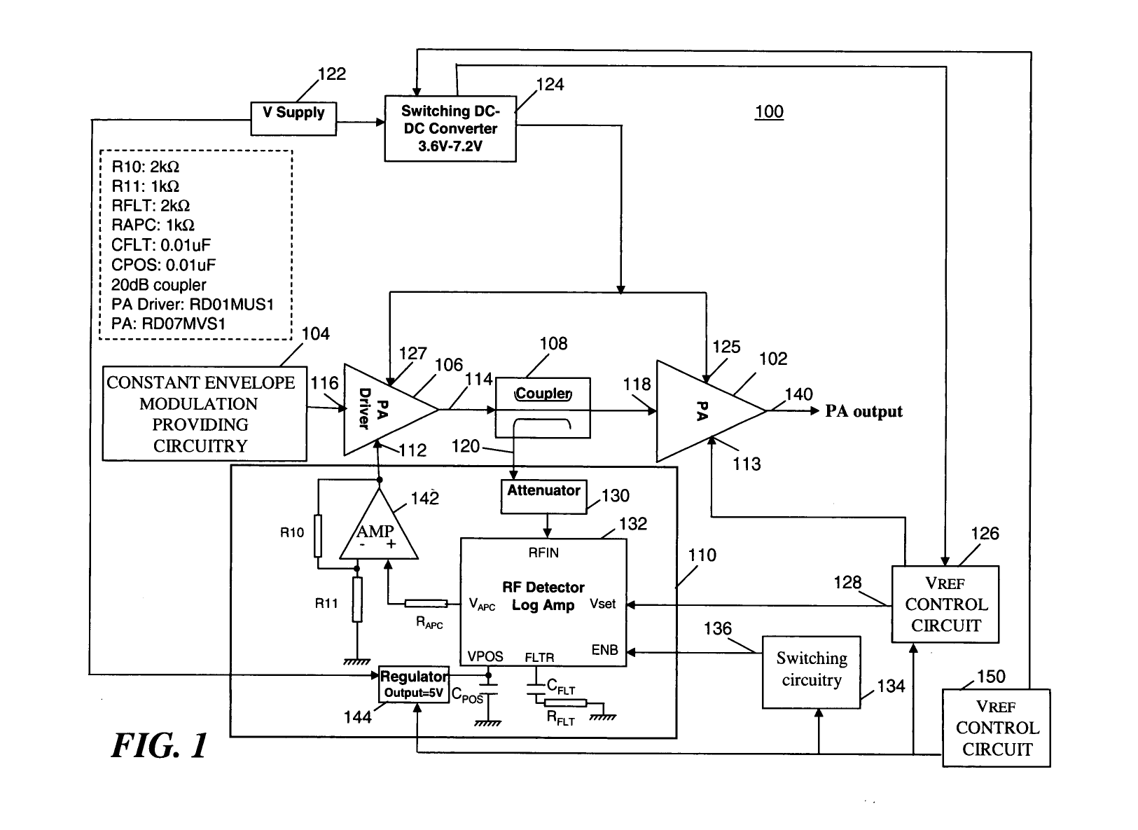

Referring to FIG. 1, there is illustrated a radio frequency power amplifier circuit 100, that may suitably form part of a radio communications device. The radio frequency power amplifier circuit 100 includes of a power amplifier 102, constant envelope modulation providing circuitry 104, a power amplifier driver 106, a sensor in the form of a coupler 108 and a feedback circuit 110. The constant envelope modulation providing circuitry 104 is typically either a frequency modulation circuit providing a frequency modulated signal or a frequency shift key modulation circuit providing a frequency shift key modulated signal.

The power amplifier driver 106 has a driver gain control input 112, a driver signal output 114, and a driver signal input 116 coupled to the constant envelope modulation providing circuitry 104. The power amplifier 102 has an amplifier input 118 that is coupled to the driver signal output 114 through the coupler 108. The coupler 108 has a coupler or sensor output 120 coupled to a radio frequency signal input of the feedback circuit 110 and an output of the feedback circuit 110 is coupled to the driver gain control input 112.

The power amplifier circuit 100 further includes a supply voltage power source 122 supplying a Direct Current (DC) Voltage to a DC voltage converter 124 that has an output coupled to respective voltage supply inputs 125, 127 of the power amplifier 102 and power amplifier driver 106. The output of the DC voltage converter 124 is also coupled to a voltage reference control circuit 126 having a reference control output 128 coupled to a control input (Vset) of a logarithmic amplifier 132 comprising part of the feedback circuit 110. The voltage reference control circuit 126 also has a power amplifier biasing output 129 coupled to an amplifier gain control input 113 of the power amplifier 102. Further, the voltage level provided at the reference control output 128 is selected depending upon the voltage level of the supply input to the power amplifier 102 from the converter 124.

The feedback circuit includes an attenuator 130 having an output coupled to a radio frequency signal input (RFIN) of the logarithmic amplifier 132. The logarithmic amplifier 132 used in the present case is typically an AD8315, which has a selected slope of 23 mV/dB and a suitable dynamic range of 50 dB. The attenuator 130 is typically a Pi network that is suitably tuned in order to fit into the log conformance region of the logarithmic amplifier 132.

The power amplifier circuit also includes switching circuitry 134 having a switching circuitry output 136 is coupled to an enabling input (ENB) of the logarithmic amplifier 132. The feedback circuit 110 also has an operational amplifier 142 with a feedback resistor RIO coupled between an output and inverting input of operational amplifier 142. The output of the operational amplifier 142 is coupled to the driver gain control input 112. Also, a resistor RI couples the inverting input to ground and a non-inverting input of operational amplifier 142 is coupled through a resistor R_{APC} to a direct current output (V_{APC}) of the logarithmic amplifier 132. A regulator 144 coupled to the supply voltage power source 122 typically provides a regulated 5 Volts direct current power supply to a Power supply input (VPOS) of the logarithmic amplifier 132. A ceramic decoupling capacitor C_{POS} connects the Power supply input (VPOS) to ground and a series capacitor C_{FLT} and resistor R_{FLT} circuit couples a filter input (FLTR) to ground for determining time domain response characteristics of the feedback circuit 110.

Also illustrated is a controller 150, typically a microprocessor, having control outputs coupled to control inputs of the voltage reference control circuit 126, switching circuitry 134, regulator 144 and converter 124. This controller 150 is usually coupled to a user interface (not shown) for receiving user command signals, transmission request commands and power mode requests for driving the power amplifier 102.

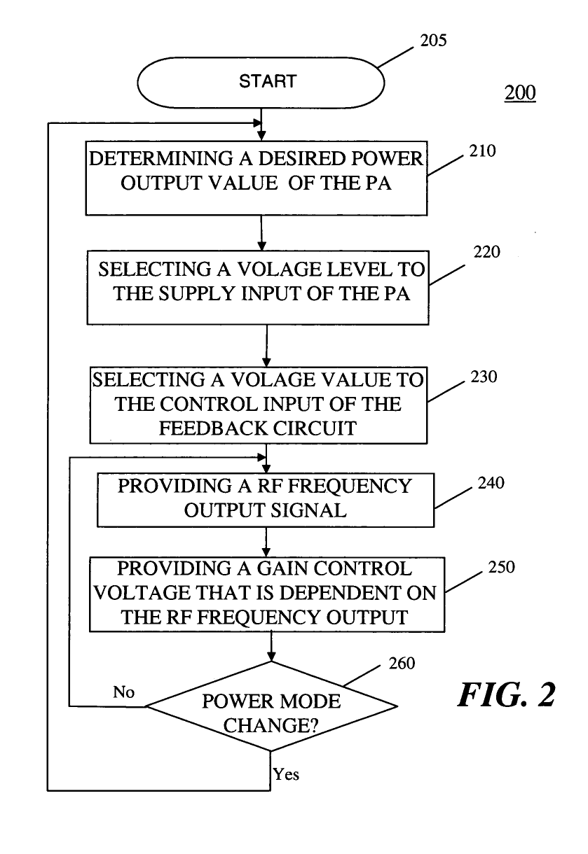

In operation, the radio frequency power amplifier circuit 100 operates as illustrated by the method 200 of FIG. 2. The method 200 provides for substantially maintaining a constant pre-defined amplitude of a constant envelope modulated radio frequency signal, supplied from circuitry 104, at the amplifier input 118 of the radio frequency amplifier 102. At block 205, the method 200 is typically initiated by a request from a user to transmit a radio frequency signal in which the radio frequency power amplifier circuit 100 is required to amplify the constant envelope modulated radio frequency signal. At block 210, there is provided determining a desired power output value of the power amplifier 102. Thereafter, in order for the radio frequency power amplifier circuit 100 to operate, block 220 performs selecting a voltage level provided to the supply input 125 of power amplifier 102. This voltage level is dependent on the desired power output value and it is determined by the converter 124 receiving a power mode request (e.g., high power or low power) transmission requirement from the controller 150. Typically, this voltage level is also provided to the supply input 127 of the power amplifier driver 106 and the switching circuit may suitably provide a supply voltage of about 5 volts to the enabling input (ENB) of the logarithmic amplifier 132. In addition, the regulator 144, controlled by the controller 150 provides a supply voltage of about 5 volts to the Power supply input (VPOS) of the logarithmic amplifier 132.

In response to the power mode request, at block 230, the converter 124 sends a control voltage to the voltage reference control circuit 126 thereby selecting a voltage value, provided by the voltage reference control circuit 126, at the control input (Vset) of the feedback circuit 110. This voltage value supplied to the control input (Vset) is dependent on the desired power output value. Also, the voltage reference control circuit 126 provides a gain control voltage to the amplifier gain control input 113 of the power amplifier 102.

In response to the above, there is an operation ramp up of the radio frequency power amplifier circuit 100 in which a bias voltage is provided from output of the amplifier 142 of feedback circuit 110 to the driver gain control input 112. Next, at block 240, there is performed providing a radio frequency output signal from the coupler 108, the radio frequency output signal is proportional to an amplitude of a constant envelope modulated radio frequency signal generated from circuitry 104 and supplied (amplified) from the power amplifier driver 106. The method 200 then, at block 250, performs providing a gain control voltage to the driver gain control input 112 of the driver 106, wherein this gain control voltage has a value dependent on the radio frequency output signal and the voltage value provided at the control input (Vset).

The method 200 then determines, at test block 260, if a power mode change request from has been received from controller 150. If there is no change in power mode requested the method 200 continuously repeats blocks 240, 250 and test 260. However, if a there is a change in power mode requested, the method goes to block 210. As will be apparent to a person skilled in the art, the method 200 terminates when the controller 150 provides an end of transmission request.

From the above, it will be apparent that the method 200 provides for maintaining a constant pre-defined amplitude of a constant envelope modulated radio frequency signal at an amplifier input 1. This is achieved by the voltage value at the direct current output (Vapc) of logarithmic amplifier 132 being controlled by comparing the voltage value at the control input (Vset) with the radio frequency output signal. Hence, the feedback circuit 110 varies the driver gain control input to maintain the amplitude of a constant envelope modulated radio frequency signal at a constant value. In this regard to improve to efficiency of the circuit 100, specifically the power amplifier 102, the voltage value provided at control input (Vset) is dependent upon the voltage level at the supply input 125 of the power amplifier 102. This selection of the voltage level at a supply input 125 and at the control input (Vset) is in response to a desired power output value (power mode) of the power amplifier 102.

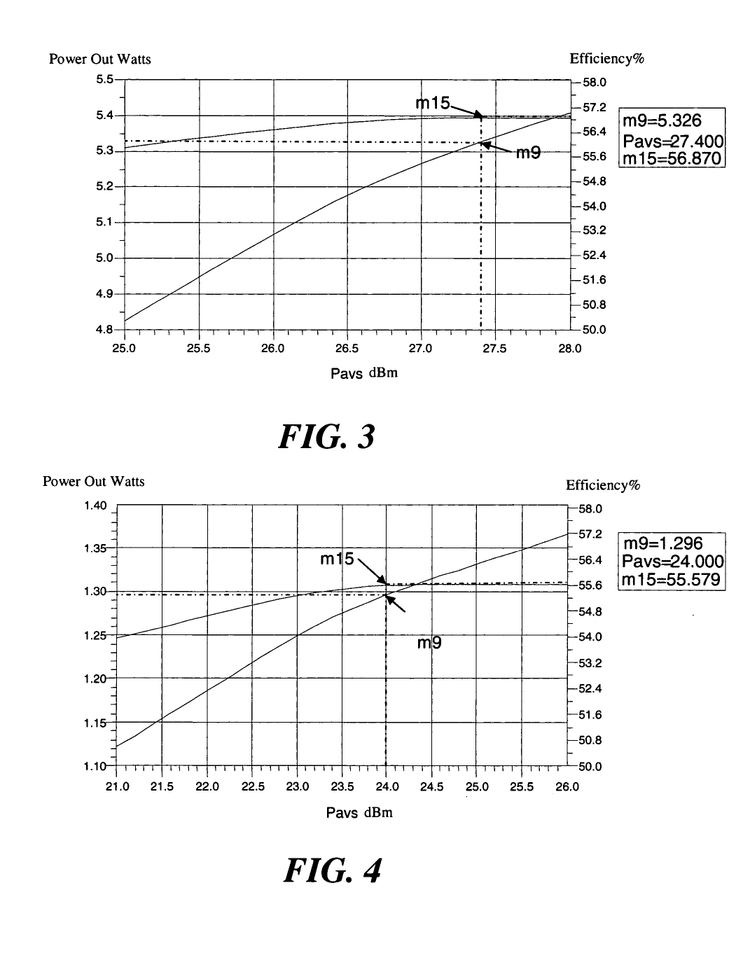

Simulations of the power amplifier circuit show a substantially constant efficiency across the power level with an RF drive (feedback provided by the feedback circuitry) and drain supply adjustment (selecting the voltage level at the supply input of the power amplifier). Referring to FIG. 3, there is illustrated graphically simulation results of efficiency versus RF drive at 7.2V supply voltage for the power amplifier circuit 100. These results are for the high power mode of 5.326 Watts requiring a 7.2V supply voltage to the supply input 125. For the 7.2V supply voltage, this high power mode of 5.326 Watts (m9) has a maximum efficiency of 56.87% (m15) when a constant envelope modulated radio frequency signal at the amplifier input 118 has amplitude (Pavs) of 27.4 dBm.

Referring to FIG. 4, again there is illustrated graphically simulation results of efficiency versus RF drive at 7.2V supply voltage for the power amplifier circuit 100. These results are for the low power mode of 1.296 Watts requiring a 3.6V supply voltage to the supply input 125. For the 3.6V supply voltage, this low power mode of 1.296 Watts (m9) has a maximum efficiency of 55.579% (m15) when a constant envelope modulated radio frequency signal at the amplifier input 118 has amplitude (Pavs) of 24 dBm.

The values identified in FIGS. 3 and 4 are used in the method 200 to obtain an efficient operation of the power amplifier 102. Also, as described above, the change in the voltage value at the reference control output 128 provides a change to the control input (Vset) of the feedback circuit 110. Therefore, adjustment of voltage values at the control input (Vset) changes the gain of the power amplifier driver, thereby adjusting the RF drive to the power amplifier. The measurement results of efficiency across various power levels are shown in table 1. The data shows that constant efficiency can be achieved across various power levels (0.5 W -6.5 W) or power modes (e.g., very high, high, medium, low, very low).

TABLE 1
Measurement results of efficiency across power level

| | | Vgs driver | | | Driver I | PA I | Drain Eff | PAE |
|---|---|---|---|---|---|---|---|---|
| Vds (V) | Vset (V) | (V) | Pwr(W) | Pwr(dBm) | (A) | (A) | (%) | (%) |
| 2.4 | 0.78 | 1.74 | 0.5 | 27.1 | 0.06 | 0.41 | 45.2 | 43.8 |
| 3.6 | 0.81 | 1.79 | 1.3 | 31.1 | 0.08 | 0.72 | 45.1 | 44.6 |
| 4.4 | 0.85 | 1.87 | 2 | 33 | 0.09 | 0.93 | 44.6 | 44.2 |
| 5.4 | 0.88 | 1.92 | 3 | 34.8 | 0.1 | 1.13 | 45.2 | 44.9 |
| 6.6 | 0.92 | 1.99 | 4.5 | 36.5 | 0.12 | 1.39 | 45.2 | 45 |
| 7.2 | 0.97 | 2.07 | 5.3 | 37.2 | 0.13 | 1.51 | 44.9 | 44.8 |
| 8 | 0.99 | 2.12 | 6.5 | 38.1 | 0.14 | 1.68 | 44.6 | 44.5 |

Advantageously, the present invention provides for substantially maintaining a pre-defined amplitude of a constant envelope modulated radio frequency signal at an amplifier input 118 wherein the gain of the driver 106 is continuously adjusted to provide efficient operation. As a result, power consumption is reduced therefore increasing operation time of the circuit 100 between charging of the supply 122 (the supply typically being a battery pack).

It will be appreciated that embodiments of the invention described herein may be comprised of one or more conventional processors and unique stored program instructions that control the one or more processors to implement, in conjunction with certain non-processor circuits, some, most, or all of the functions of the radio frequency power amplifier circuit described herein. The non-processor circuits may include, but are not limited to, a radio receiver, a radio transmitter, signal drivers, clock circuits, power source circuits, and user input devices. As such, these functions may be interpreted as steps of a method to substantially maintain the RF amplified signal at a constant predefined amplitude. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

In the foregoing specification, a specific embodiment of the present invention has been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defmed solely by the appended claims including any amendments made during the pendency of this application and all equivalents of those claims.

We claim:

1. A radio frequency power amplifier circuit comprising:
a constant envelope modulation providing circuitry;
a power amplifier driver having a driver gain control input, a driver signal output, and a driver signal input coupled to the constant envelope modulation providing circuitry;
a power amplifier having an amplifier input coupled to the driver signal output;
a sensor having a sensor output and a sensor input coupled with the amplifier input; and
a feedback circuit having an input coupled to the sensor output and an output coupled to the driver gain control input,
wherein in operation the sensor output provides a radio frequency output proportional to an amplitude of an amplified constant envelope modulated radio frequency signal provided to the amplifier input from the driver signal output, and wherein the feedback circuit provides a gain control voltage to the driver gain control input, the gain control voltage having a value dependent on the radio frequency output thereby substantially maintaining the amplified constant envelope modulated radio frequency signal at a constant pre-defined amplitude.

2. A radio frequency power amplifier circuit as claimed in claim 1, the circuit further including a supply voltage controller coupled to a voltage supply input of the power amplifier, and wherein use the constant pre-defined value of the amplified constant envelope modulated radio frequency signal is dependent upon the voltage level at the supply input of the power amplifier.

3. A radio frequency power amplifier circuit as claimed in claim 2, wherein the circuit further includes a voltage reference control circuit having a reference control output coupled to a control input of the feedback circuit.

4. A radio frequency power amplifier circuit as claimed in claim 3, wherein a voltage provided at the output of the voltage reference control circuit is dependent upon the voltage level of the supply input of the power amplifier.

5. A radio frequency power amplifier as claimed in claim 4, wherein the feedback circuit compares the voltage value provided at the reference control output with a voltage value resulting from the radio frequency output to provide the gain control voltage.

6. A radio frequency power amplifier circuit as claimed in claim 5, the circuit further including a switching converter having an input coupled to output of the voltage reference control circuit and output coupled to supply input of the power amplifier.

7. A radio frequency power amplifier circuit as claimed in claim 5, wherein the feedback circuit includes a logarithmic amplifier.

8. A radio frequency power amplifier as claimed in claim 1, wherein the constant envelope modulation providing circuitry is from a set including frequency modulation circuitry and frequency shift key modulation circuitry.

9. A method for substantially maintaining a constant pre-defined amplitude of a constant envelope modulated radio frequency signal at an amplifier input of a radio frequency amplifier, the method comprising:
selecting a voltage value provided at a control input of a feedback circuit;
providing a radio frequency output signal that is proportional to an amplitude of a constant envelope modulated radio frequency signal from a power amplifier driver having an output coupled to the input of a power amplifier; and
providing a gain control voltage to a gain control input of the driver, the gain control voltage having a value dependent on the radio frequency output signal and voltage value provided at the control input.

10. A method as claimed in claim 9, wherein the voltage value provided at control input of feedback circuit is dependent upon the voltage level to a supply input of the power amplifier.

11. A method as claimed in claim 10, wherein the selection of the voltage level at a supply input and at the control input of feedback circuit are in response to a desired power output value of the power amplifier.

12. A method as claimed in claim 9, wherein the gain control voltage is provided by a circuitry including a logarithmic amplifier.

13. A method as claimed in claim 12, wherein the gain control voltage is provided by the voltage value provided at the reference control input being compared with a voltage value resulting from the radio frequency output signal.

14. A method as claimed in claim 9, wherein the constant envelope modulated radio frequency signal is one of a frequency modulated signal, or a frequency shift key modulated signal.

15. A method as claimed in claim 9, wherein there is a prior step of selecting a voltage level provided to a supply input of the power amplifier.

16. A method for substantially maintaining a constant pre-defined amplitude of a constant envelope modulated radio frequency signal, at an amplifier input to a radio frequency amplifier, the method comprising:
determining a desired power output value of a power amplifier;
selecting a voltage level provided to a supply input of a power amplifier, the voltage level being dependent on the desired power output value;
selecting a voltage value provided at a control input of a feedback circuit, the voltage value being dependent on the desired power output value;
providing a radio frequency output signal that is proportional to an amplitude of a constant envelope modulated radio frequency signal from a power amplifier driver having an output coupled to input of power amplifier; and
providing a gain control voltage to a gain control input of the driver, the gain control voltage having a value dependent on the radio frequency output signal and voltage value provided at the control input.

17. A method as claimed in claim 16, further comprising of switching the desired power output.

18. A method as claimed in claim 16, wherein the gain control voltage is provided by circuitry including a logarithmic amplifier.

19. A method as claimed in claim 18, wherein the gain control voltage is provided by the voltage value provided at the reference control output being compared with a voltage value resulting from the radio frequency output signal.

20. A method as claimed in claim 16, wherein the constant envelope modulated radio frequency signal is one of a frequency modulated signal, or a frequency shift key modulated signal.
